(19) United States
(12) Patent Application Publication
(10) Pub. No.: US 2013/0212201 A1
(43) Pub. Date: Aug. 15, 2013

(54) ON-DEMAND MARKETING LITERATURE DISTRIBUTION SYSTEM

(71) Applicants: Brian Walters, Canal Fulton, OH (US); Patrick Scott McLaughlin, Cleveland, OH (US); Scott McLaughlin, Canal Fulton, OH (US)

(72) Inventors: Brian Walters, Canal Fulton, OH (US); Patrick Scott McLaughlin, Cleveland, OH (US); Scott McLaughlin, Canal Fulton, OH (US)

(21) Appl. No.: 13/766,928

(22) Filed: Feb. 14, 2013

Related U.S. Application Data
(60) Provisional application No. 61/598,591, filed on Feb. 14, 2012.

(51) Int. Cl. H04L 12/24

(52) U.S. Cl. CPC H04L 41/026
USPC 709/206

(57) ABSTRACT

A literature on demand (LOD) distribution system comprises a secure server hosting a LOD database and a vendor's electronic data processing device on which a LOD application is loaded. The vendor's electronic data processing device is configured to execute the LOD application to perform operations including: storing a local LOD database containing a portion or all of the LOD items stored in the LOD database at the secure server; selecting an LOD item stored in the local LOD database; displaying the selected LOD item or causing the selected LOD item to be displayed by a viewer application executing on the electronic data processing device; constructing an email including a hyperlink for downloading or streaming the selected LOD item from the LOD database of the secure server; and sending the constructed email to a recipient or causing the constructed email to be sent to the recipient by an email application executing on the electronic data processing device.

This application claims the benefit of U.S. Provisional Application No. 61/598,591 filed Feb. 14, 2012 and titled “ON-DEMAND MARKETING LITERATURE DISTRIBUTION SYSTEM”. U.S. Provisional Application No. 61/598,591 filed Feb. 14, 2012 titled “ON-DEMAND MARKETING LITERATURE DISTRIBUTION SYSTEM” is hereby incorporated by reference in its entirety into the specification of this application

### BACKGROUND

The following relates to the marketing arts, retail and service provider arts, marketing publications distribution arts, pricing information distribution arts, and related arts.

Trade shows are a common venue for the marketing of products and services. A seller typically attends the trade show in the role of a vendor, and sets up a vendor's booth staffed by sales personnel. Potential customers visit the booth and a salesperson makes a sales pitch, which typically includes talking up the product or service, possibly in conjunction with audio/visual aids such as posters, video clips, or so forth. The sales staff also hands out product or service literature, in the hope that the visitor will retain these materials, refer to them, and follow up with further inquiries and ultimately purchases. This literature may include generic product brochures, or may include time-sensitive material such as current price lists and/or trade show-specific material such as a price discount coupon for trade show attendees. The sales staff also attempts to maintain a tally of visitors, preferably by name and company affiliation in order to enable sales personnel to follow up after the trade show with telephone calls, emails, or the like.

The vendor's web site is often leveraged at the trade show as a synergistic marketing tool. For example, the distributed literature typically includes the vendor's website URL (“uniform resource locator”) address. The hope is that customers who visit the booth will follow up by visiting the vendor's website, where they may obtain access to more detailed literature available for download, or can send questions via a contact page of the website, or perhaps even make on-line purchases.

After the trade show, some effort may be made to assess the effectiveness of the trade show as a marketing tool. For example, customers may be asked to complete questionnaires that elicit information about where the customer heard about the product, and responses indicating the trade show are tracked. Purchases made after the trade show, or visits to the vendor's website, may be correlated with the tally of booth visitors.

These approaches have certain disadvantages, some of which are outlined below.

One disadvantage is printing and delivery cost. It is not uncommon for box loads of marketing literature to be printed and shipped to the trade show, at substantial expense to the vendor. Since the vendor does not want to run out of literature at the trade show (and thereby perhaps lose potential customers), the quantity of literature that is printed exceeds the expected demand. Endeavoring to maximize sales, the vendor typically prints glossy brochures of the highest quality, which also maximizes the printing costs.

Another disadvantage is the possibility of information theft. Very little prevents a business competitor from visiting the booth and collecting literature. This can be particularly problematic where sensitive information such as price lists are provided at the booth, or when the product or service is of such a nature that it is otherwise difficult to obtain information about it. The vendor's website is also vulnerable—competitors can use the URL address provided at the booth just as easily as legitimate customers.

Another disadvantage is that existing approaches for assessing the marketing effectiveness of the vendor's booth are limited. Although sales staff attempt to tally visitors, they may fail to adequately identify some potential customers in a manner that enables effective follow-up (for example, they may fail to collect email addresses). Also, there is no assurance that any particular visitor is really interested in making a purchase, or even will read literature hand-delivered to the visitor. The waste receptacles of trade shows are usually filled with discarded marketing literature. Often a visitor will accept literature from a sales person just to be sociable, and without any intention of following up and investigating (much less actually purchasing) the product or service.

Other methods for assessing booth effectiveness are also suspect. Correlating booth visitor tallies with subsequent website visits and/or purchases is difficult, and makes questionable assumptions about cause-and-effect (i.e., it is assumed that the website visit or purchase was motivated by the booth visit).

Another disadvantage is that the marketing literature handed out at the trade show is of limited size and resolution. Even if glossy brochures of highest quality are printed, practical considerations constrain the literature to be no larger than about the size of a typical sheet of paper, e.g. about 8.5×11 inches or perhaps slightly larger. A fold-out brochure may partially relax this size constraint in one dimension; nonetheless, the physical constraints limit the resolution of illustrations and other graphical content. One may hope that the literature will be augmented by content posted at the vendor's website, where the customer can zoom in on images, view animations, or so forth—but this assumes that the customer actually remembers and is motivated to visit the website, and is successful in navigating hyperlinks to the postings of interest.

More generally, the passive nature of a visit to a vendor's booth is problematic. On the one hand, having sales staff actively push literature to the visitor is arguably better than passively waiting for visitors to request literature. However, when the visitor receives literature without making even a modicum of effort on the visitor's part (and perhaps even against the wishes of the visitor), it is difficult to accurately gauge the visitor's true interest in the product or service.

### BRIEF SUMMARY

In some embodiments disclosed herein, literature on-demand (LOD) distribution system comprises a vendor's electronic data processing device on which a LOD application is loaded. The vendor's electronic data processing device is configured to execute the LOD application to perform operations including: storing a local LOD database containing a portion or all of the LOD items stored in a LOD database hosted at a secure server; selecting an LOD item stored in the local LOD database; displaying the selected LOD item or causing the selected LOD item to be displayed by a viewer application executing on the vendor's electronic data processing device; constructing an email including a hyperlink for downloading or streaming the selected LOD item from the LOD database of the secure server; and sending the constructed email to a recipient or causing the constructed email to be sent to the recipient by an email application executing on the vendor's electronic data processing device. In some embodiments the vendor's electronic data processing device is a mobile device, such as a tablet computer, or a notebook or desktop computer.

In some embodiments disclosed herein, a non-transitory storage medium stores instructions executable by an electronic data processing device to perform a method including: selecting a literature on-demand (LOD) item stored in a local LOD database containing content downloaded from an LOD database hosted at a secure server; displaying the selected LOD item or causing the selected LOD item to be displayed by a viewer application executing on the electronic data processing device; constructing an email including a hyperlink for downloading or streaming the selected LOD item from the LOD database of the secure server; and sending the constructed email to a recipient or causing the constructed email to be sent to the recipient by an email application executing on the electronic data processing device.

In some embodiments disclosed herein, a literature on-demand (LOD) distribution system comprises a server connected with the Internet and hosting a LOD database storing LOD items, the server configured to: connect with authenticated mobile electronic data processing devices via the Internet and download portions or all of the LOD items stored in the LOD database to the authenticated mobile electronic data processing devices via the Internet connection; and transmit or stream a LOD item to a recipient electronic data processing device via the Internet responsive to receipt of a request for the LOD item by selection of a hyperlink at the recipient's electronic data processing device identifying the LOD item.

### BRIEF DESCRIPTION OF THE DRAWINGS

FIG. 1 diagrammatically shows an on-demand marketing literature delivery system and selected associated components.

FIG. 2 diagrammatically shows functional and data blocks of the literature on-demand (LOD) tablet computer application.

FIG. 3 diagrammatically shows a method for reviewing and sending on-demand literature to a booth visitor using the LOD tablet computer application.

FIG. 4 diagrammatically shows an emailer data entry dialog suitably displayed by the LOD tablet computer application, with data filled in for illustrative booth visitor “John Brown” of “Corporate Corp”.

FIG. 5 diagrammatically shows an email message received by illustrative visitor John Brown which was generated by the method of FIG. 3 and the input data shown in the emailer data entry diolog of FIG. 4.

FIG. 6 diagrammatically shows a method performed by illustrative visitor John Brown upon receipt of the email message of FIG. 5.

FIG. 7 diagrammatically shows a method performed by the secure server of FIG. 1 upon receipt of a download or stream request from illustrative visitor John Brown generated by the method of FIG. 6.

### DETAILED DESCRIPTION OF PREFERRED EMBODIMENTS

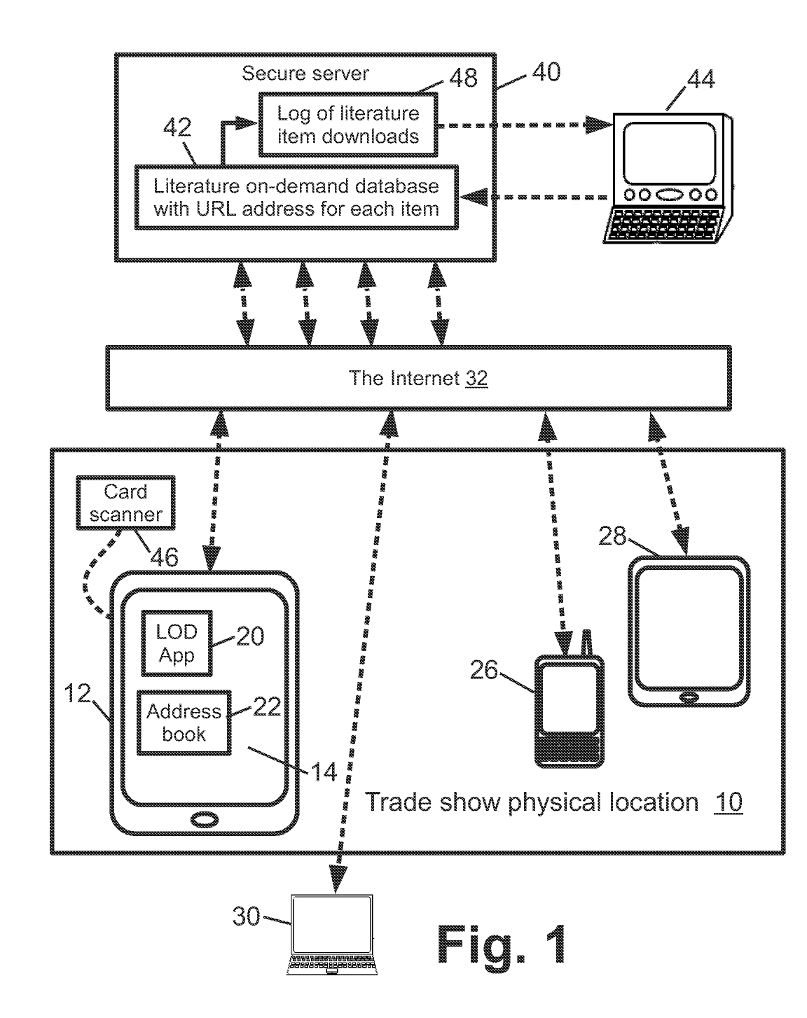

With reference to FIG. 1, a literature on-demand (LOD) system is described in the context of a trade show. The trade show has a physical location 10, at which a vendor's booth (not shown) is occupied by sales staff operating an electronic data processing device 12 having a display device 14. The illustrative electronic data processing device 12 is a tablet computer, such as an IPad™ (available from Apple Corp., Cupertino, Calif., USA) or a tablet computer running the Android™ operating system (available from Google, Mountain View, Calif., USA). However, the electronic data processing device 12 may be another type of device, such as a notebook computer, desktop computer, smart phone, or so forth. In some such devices, such as a desktop computer, the display device may be separate from the electronic data processing device. A LOD application 20 is loaded onto the electronic data processing device 12 and is executable by the electronic data processing device 12. In the context of mobile devices such as tablet computers or smartphones, such an application is sometimes colloquially referred to as an “app”. In the context of a notebook or desktop computer, such an application is sometimes referred to as a “program” or “application program”. Other applications may be loaded onto and executable by the electronic data processing device 12, such as an illustrative address book application 22 which stores information about selected persons such as names, email addresses, mailing addresses, telephone numbers, corporate affiliations, and so forth. The electronic data processing device 12 is generally under the control of a sales person working the vendor's booth, or of the booth sales staff collectively, in the sense that the sales person or staff is the owner, lessee, bailee, or guardian of the device 12 and generally maintains possession of the device 12. However, it is to be understood that the electronic data processing device 12 (especially if a mobile device) may occasionally be temporarily handed to a visitor for the visitor to view subject matter shown on the display 14.

Any given visitor at the trade show may, or may not, carry his or her own personal mobile electronic data processing device, such as an illustrative smart phone 26, an illustrative tablet computer 28, a personal data assistant (PDA, not shown), or so forth. Any given visitor at the trade show may also have access to an electronic data processing device that is not at the trade show, such as an illustrative computer 30 which may be located at the visitor's home or office (by way of example). It will also be appreciated that these various devices 26, 28, 30 (especially the mobile devices) may be moved about—for example, the visitor may have the cell phone 26 at the trade show physical location 10, and also carry it with him or her back to the office after the trade show is over.

All of these devices 12, 26, 28, 30 are in operative communication with the Internet 32 via various mechanisms such as wired or wireless networks e.g., wired Ethernets, wireless WiFi networks, 3G or 4G cellular networks, electronic mail (email) servers, firewalls, or so forth. The Internet 32 and these intermediary pathways and/or devices enable selective interconnectivity between the devices 12, 26, 28, 30 and between the devices 12, 26, 28, 30 and a secure server 40 (which may, by way of illustrative example, be a server computer, desktop computer, or so forth, and which may in some embodiments be embodied by a computing “cloud” comprising a plurality of interconnected servers and/or computers). By “selective” communication it is meant that there is some control, which may be manual, automatic, or semi-automatic, that constrains the parties and the communicated content. Intercommunication amongst the devices 12, 26, 28, 30 is suitably via email, where the control is provided by the use of email addresses designating the sender and recipient and constraints on email content imposed by the email servers and/or email software running on the devices. Communication of the devices 12, 26, 28, 30 with the secure server 40 is typically via a secure hypertext transfer protocol (HTTP) connection, with the communicating devices being designated by uniform resource locator (URL) addresses. Firewalls or other security measures may impose further constraints.

The electronic data processing device 12 (hereinafter referred to by the illustrative embodiment of a vendor's tablet computer 12) executes the LOD application 20 (hereinafter referred to as the LOD app 20 as per the tablet computer context) in order to download, present, and distribute literature on-demand. More particularly, the secure server 40 stores a literature on-demand (LOD) database 42, with each item of literature having an associated URL address. The LOD app 20 downloads selected (or all) items of literature in the LOD database 42 from the secure server 40 to the tablet computer 12 via the Internet 32. For example, the LOD database 42 may be maintained by personnel accessing the secure server 40 directly or by a terminal device 44 (as shown). The terminal device 44 suitably connects with the secure server 40 by a direct wired connection (e.g., Ethernet), and/or by a local wireless connection (e.g., a WLAN network), and/or by the Internet 32 (option not shown in FIG. 1). An administration application (not shown) executing at the secure server 40 and/or at the terminal device 44 enables a system administrator to log on into the “backend” of the secure server 40 to perform maintenance operations such as adding, updating, or deleting items contained in the LOD database 42. In some embodiments the administration application also enables the database administrator to customize the appearance of the graphical user interface (GUI) presented on the tablet computer 12 by the LOD app 20. The GUI “template” may, for example: include a corporate logo, name, trademark, or the like; define a skin that is used for displaying buttons, backgrounds, or other aspects of the GUI of the LOD app 20; a chosen color scheme and/or selected font or fonts; and so forth. In such embodiments, when the tablet computer 12 connects with the secure server 40 to update media content, it also requests the GUI template, which will then be stored locally on the tablet computer 12 in a file or data structure associated with (or integral with) the LOD app 20. Alternatively, some of these GUI aspects may be “hard coded” into the LOD app 20, or may be locally user-selectable options. Hard-coded or local user-selectable GUI aspects are optionally updated as part of an occasional new version update of the LOD app 20 (for example, the LOD app 20 may be downloaded and occasionally updated via an online store or marketplace).

Typically, all literature that may credibly be distributed to potential customers is loaded into the LOD database 42; however, not all of that literature may be credibly be expected to be of interest to attendees of the trade show. For example, if the trade show pertains to maritime applications, then literature pertaining to terrestrial applications may be of little or no interest to show attendees. Prior to commencement of the trade show, the sales staff downloads items of literature that are credibly expected to be of possible interest to visitors to the trade show onto the tablet computer 12. This loading process may also update any items of literature that have been revised since the content of the tablet computer 12 was last updated. Typically, each tablet computer 12 is registered at the secure server 40 (for example, using the device's unique identifier, UDID, or other electronic device identifier) or is otherwise authenticated by the secure server 40 (e.g. by receiving a suitable username/password authentication, an encrypted key-based authentication, or so forth) in order to be authorized to perform such (partial or entire) database downloading. At the show, the LOD app 20 is used by booth sales staff to present literature items to interested booth visitors visually via the display device 14 of the tablet computer 12. (The display device 14 may be the built-in screen of the tablet computer 12, as shown, or may additionally or alternatively be a large LCD monitor, projector display, or so forth in operative communication with the tablet computer 12 via a Bluetooth™ wireless connection or the like). Advantageously, literature in the form of a portable document format (PDF) file or other electronic format can be zoomed or otherwise manipulated to enhance readability. Moreover, the literature on-demand (LOD) is not limited to documents, but can also include animations, images, video clips, or so forth. If the visitor is sufficiently interested, the literature item may be sent to the visitor electronically, also using the LOD app 20. Toward this end, the sales person uses the LOD app 20 to generate and send a personalized email that includes hyperlinks comprising the URL addresses of literature items requested by the visitor. The visitor's email address can be entered manually, or if the visitor is a past customer or is otherwise already in the address book 22 then the visitor's email address can be populated from the address book 22. As another option, a business card scanner 46 can be used to read the visitor's business card, or a radio frequency identification (RFID) tag in the business card, in order to acquire the visitor's email address (and optionally other information such as the name, business affiliation, et cetera). The visitor can then, at his or her leisure, open the received email message and select the hyperlink to cause the LOD item to be downloaded (or, alternatively, streamed, e.g. in the case of a video clip) from the secure server 40 to the visitor's computer or device 26, 28, 30. When the download or streaming occurs, the server 40 adds the download to a log 48 of literature item downloads. Because the HTTP connection identifies the download (or stream) requestor, this logging can be specific, e.g. identifying the particular person (i.e., trade show visitor) who requested the download. The logged download (or stream) request information can be offloaded to the terminal device 44 for review by the sales department or other company personnel in order to assess the effectiveness of the trade show as a marketing tool.

The disclosed LOD system of FIG. 1 has numerous advantages over existing literature distribution systems. Some of these advantages are as follows. By using the tablet computer 12 to display literature to visitors, the limitations of printed brochures are overcome. The display can be zoomed or otherwise manipulated to enhance readability, and moreover other media types such as video clips or animations are readily shown. Literature printing and shipping costs are also eliminated. The possibility of information theft is reduced (although not eliminated) since the secure server 40 can incorporate security measures such as a “do-not-send” list to prevent sending LOD to URL addresses known to be associated with commercial competitors. Theft may also be deterred to some extent since the trade show visitor may reasonably expect the download or stream to be traceable to the visitor. The literature download/stream log 48 also provides an effective way to assess the effectiveness of the trade show as a marketing tool, as it identifies with particularity which visitors elected to download or stream items of literature, and identifies the literature that was downloaded or streamed. Still further, the disclosed LOD system incorporates affirmative action by the visitor, in that the visitor must choose to download or stream the item of literature. Accordingly, visitors who are only being sociable in accepting literature are screened out, as such visitors are likely to simply delete the email without downloading the literature items. In some embodiments the literature download/stream log 48 provides analytics to the system administrator, e.g. via the terminal device 44. Such analytics may, for example, include download/stream statistics as a function of the tablet computer 12, and/or as a function of salesperson (in situations in which the tablet computer 12 is shared amongst two or more salespersons), and/or as a function of the trade show, or so forth. Optionally, such analytics may be output in a graphical or other easy-to-comprehend format, and/or may optionally be generated in multiple graphical formats for consideration by the system administrator and for delivery to the salesperson or salespeople. The system administrator may, for example, be able to send a PDF version of relevant analytics to the sales person's tablet computer 12 at the end of each day of the trade show, so that the sales person has up-to-date information on which visitors have actually downloaded literature.

The disclosed LOD system of FIG. 1 has numerous further advantages that have no analog in existing literature distribution systems. Some of these advantages are as follows. While enabling the viewing of literature on-demand in electronic format, the LOD system does not need to maintain a connection with the Internet 32. This is because the literature can be downloaded ahead of time. (On the other hand, if an Internet connection is available this can be usefully employed to download or stream literature from the secure server 40 in the event that a visitor is interested in subject matter for which literature is available but was not downloaded ahead of time). The use of email for LOD distribution also enables “off-line” distribution, since in the absence of an Internet connection the email will be retained or queued until a connection is available (so that a current Internet connection for the vendor's table 12 is not necessary). Similarly, the email will sit in the visitor's email in-box until next accessed by the visitor, so that a current Internet connection of the visitor's mobile device 26, 28 is also not needed. (Indeed, even if the visitor has no mobile device, the email can be sent and then read by the visitor at home or in the office via the computer 30). The email also cannot be lost in the way that printed literature can be lost, and is only deleted if the visitor take the affirmative action of deleting the email (in which case the visitor presumably was not genuinely interested in the product or service). The use of hyperlinks also reduces the size of the email over directly emailing a literature item as an attachment. Still further, since the visitor downloads or streams the literature item from the secure server 40, it can be assured that the delivered content is up-to-date.

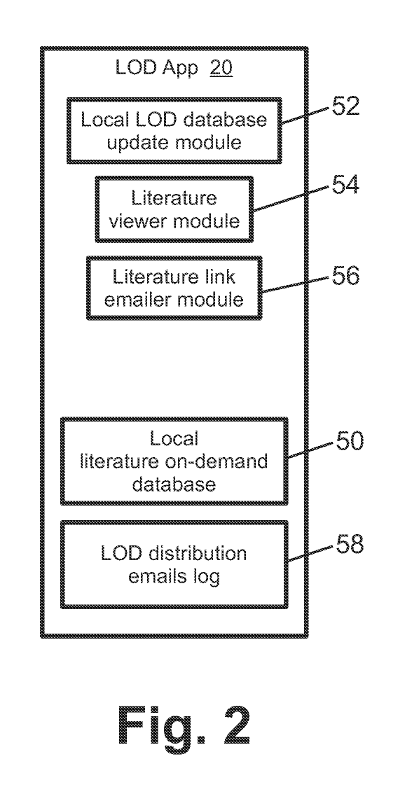

With reference to FIG. 2, functional and data elements of an illustrative embodiment of the LOD app 20 are diagrammatically shown. The LOD app 20 includes a local literature on-demand (LOD) database 50 that is populated by a local LOD database update module 52. That is, the local LOD database update module 52 connects with the secure server 40 to download all LOD items in the server LOD database 42, or to download only selected LOD items. In a suitable approach (not illustrated), the secure server 40 maintains an index (optionally sortable and optionally searchable) of LOD items stored in the LOD database 42, preferably including metadata such as revision date, expiration date (i.e., a LOD item may have an expiration date and become unavailable for download after that expiration date), product category, or so forth. This index (which is text-based or comprises some encoding scheme and accordingly is not large) is downloaded in its entirety to the tablet computer 12 by the LOD database update module 52, and is displayed for the user in a suitable readable format. The user can then select literature items for download. The selection can be by individual item, and/or by a suitable aggregate selection mechanism (e.g., selecting all literature items in a particular product category). Once the selection is complete, the user initiates the download and the selected LOD items are downloaded via an HTTP link between the secure server 40 and the tablet computer 12. Items already on the tablet computer are typically not re-downloaded unless the revision date for the local copy is older than the revision date of the LOD item at the server 40.

The LOD app 20 also includes a literature viewer module 54 that provides a graphical user interface (GUI) via which the sales person can display the LOD item to a booth visitor. The literature viewer module 54 may include more than one viewer, e.g. one viewer module for each media type (e.g., a PDF viewer, a text document viewer, a video display engine, an audio playback module, et cetera). Moreover, in some embodiments the literature viewer module 54 may be an application that is separate from the LOD app 20 and is accessed by the LOD app 20 via suitable hooks, or as a plug-in program or application. For example, the LOD app 20 may invoke a standalone media player application to display video or audio clips. The literature viewer module 54 typically includes a selection component providing the sales person with a list of the downloaded items available for presentation to the visitor. In some embodiments, the selection component enables editing of the contents of the list, for example based on the particular visitor to whom the sales pitch is being made. By way of illustration, preferred (e.g. large-volume) customers may be offered lower prices, and so the list may be editable to choose literature offering prices appropriate for the current visitor.

If the sales pitch is successful, then the visitor is likely to request a copy of the literature item(s) that were presented by the literature viewer module 54 (and perhaps other items that were not presented). In this event, a literature link emailer module 56 is invoked, via which the sales person composes and sends an email to the visitor which includes hyperlinks comprising the URL addresses of the requested LOD items. The literature link emailer module 56 may be configured to directly send the email, or may be hooked into or otherwise operatively connected with a standalone email program or application that is loaded onto and executable by the tablet computer 12—in this case, the emailer module 56 constructs the email and forwards it to the standalone email program which actually sends out the email. The literature link emailer module 56 optionally also logs information about LOD distribution emails in a LOD distribution emails log 58. The logged information may include, by way of example: identification of the recipient and the distributed items; time and date of the email; whether the email was received; and so forth. The logged information can be variously used. For example, comparison of the email log 58 with the log 48 of items actually downloaded (or streamed) provides a way to assess the fraction of booth visitors that were genuinely interested in the vendor's products or services (as opposed to simply accepting literature to be sociable). In some cases, the email log 58 may be used to identify potential customers who did not follow up by downloading (or streaming) LOD items, so that suitable follow-up can be performed after the trade show.

The LOD app 20 executes on the vendor's electronic data processing device (e.g., vendor's tablet computer) 12. The LOD app 20 may also be embodied as non-transitory storage medium storing instructions executable by an electronic data processing device to perform the LOD app method operations. The non-transitory storage medium may, for example, comprise: a hard disk drive, solid state electronic drive (e.g., FLASH memory), or other storage of the tablet computer 12; or may comprise a RAID or other storage of an Internet-based server from which the LOD app 20 may be downloaded; or may comprise a DVD or other optical disk or optical medium on which the LOD app 20 is distributed; or may comprise random access memory (RAM) of the tablet computer 12 into which the LOD app 20 is loaded in order to execute the LOD app 20; or so forth.

With reference to FIGS. 3-7, an illustrative example of the literature distribution process is described for an illustrative visitor named “John Brown” who is affiliated with “Corporate Corp.” The sales person in this illustrative example is Ted Smith representing the vendor “Widgets Inc.”.

With reference to FIG. 3, in an operation S1, John Brown has visited the vendor's booth, and salesman Ted has talked with visitor John and presented John with the brochure for the product “Widget.1” via the literature viewer module 54 of the LOD app 20. John expresses some interest in this product, and indicates that he would like to receive literature on the Widget.1 model. Ted proposes to send the brochure for Widget.1, as well as a brochure on the entire Widgets line produced by Widgets, Inc. Ted also proposes to send a price list for the Widgets line. (This price list may or may not be presented as a binding quote from Widgets, Inc., depending upon company policy—the price list may include suitable text indicating whether it constitutes a binding price quote or merely a current price list to be verified at the time of product ordering).

In an operation S2, salesman Ted selects the email recipient, i.e. John Brown. This can be done in various ways, e.g. manually be asking for and typing in John's email address (and preferably other information such as his name and corporate affiliation), or by retrieving John's information from the address book 22, or by using the card scanner 46 to scan John Brown's business card (or to scan an RFID in the business card).

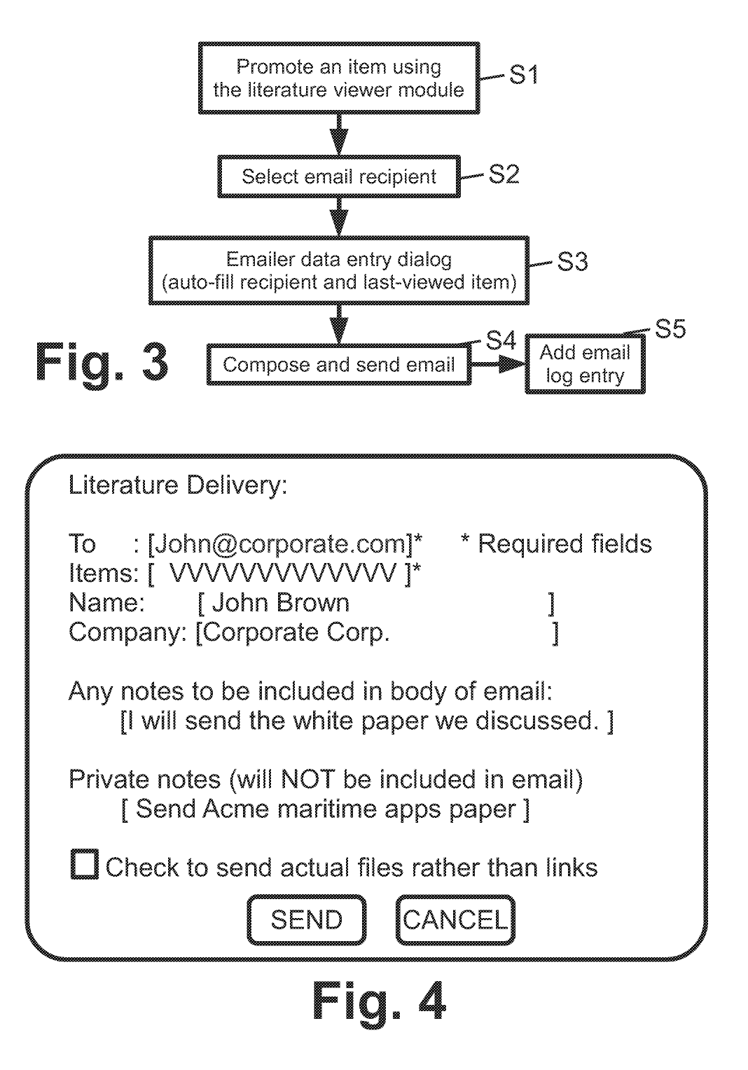

With continuing reference to FIG. 3 and with brief reference to FIG. 4, the operation S2 leads into operation S3 in which the literature link emailer module 56 (see FIG. 2) is invoked and displays an emailer data entry dialog. FIG. 4 shows an illustrative example of an emailer data entry dialog that has been filled in with the information for sending the requested literature to John Brown. In some embodiments the dialog is automatically populated with recipient information (from operation S2) and optionally also with the identity of the last item viewed via the literature view module 54. In the illustrative example of FIG. 4, the dialog includes fields for entering the recipient's email address, the items for distribution (these are required fields), and the recipient's name and affiliation. While the items field may be automatically populated as previously mentioned, it may also be loaded manually. In one suitable approach, the items field constitutes a drop-down box or other list-based dialog mechanism that lists the items that are available for distribution.

The illustrative dialog of FIG. 4 also includes a field where the sales person can enter any additional information to be included in the body of the email, and a “private notes” field in which the sales person can enter any notes for his or her personal use (suitably stored, for example, in the LOD distribution emails log 58, see FIG. 2). The illustrative example of FIG. 4 is premised on a scenario in which Ted and John discussed maritime applications of the Widget.1 product, and salesman Ted promised to send visitor John a white paper on the subject by an entity called “Acme”. In the context of this illustrative scenario, salesman Ted enters “I will send the white paper we discussed.” In the field for additional email body text, and enters “Send Acme maritime apps paper” in the “personal notes” field. The illustrative emailer data entry dialog of FIG. 4 also includes a checkbox labeled “Check to send actual files rather than links.” This is an field that may optionally be included in the emailer data entry dialog—if included and checked, then rather than sending hyperlinks to the literature items the email includes the literature items as actual attachments to the email. This may be a desirable approach if, for example, visitor John is a longtime trusted customer for whom the convenience of actual attachments is advantageous. A disadvantage of sending the items as actual attachments is that in this case the items are not downloaded from the secure server 40 and hence are not logged into the log 48.

With continuing reference to FIG. 3, in an operation S4 the literature link emailer module 56 composes the email based on the filled-in contents of the emailer data entry dialog, and sends (or invokes the standalone email program to send) the composed email to the recipient (in this case, to visitor John Brown). In an operation S5 the literature link emailer module 56 adds information about this email to the LOD distribution emails log 58 (see FIG. 2).

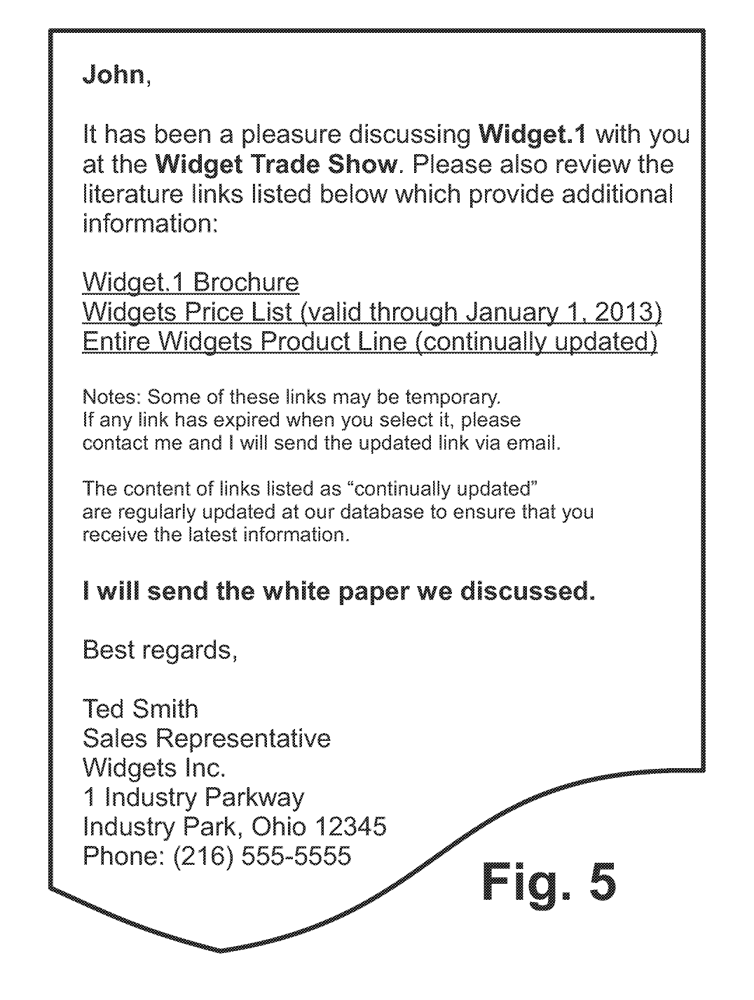

With reference to FIG. 5, the illustrative email to John Smith corresponding to the contents of the filled-in dialog of FIG. 4 is shown. In diagrammatic FIG. 5, regular text indicates content of a “form letter” while boldface text is used to show fields of the email that are filled in based on contents of the emailer data entry dialog, and underscoring is used to indicate the hyperlinks to the LOD items. (If the tablet computer 12 is shared amongst two or more salespersons, then the identity of the salesperson may optionally be a field of the dialog and hence a “filled in” portion of the email). The hyperlinks of FIG. 5 also illustrate some contemplated features that are optionally incorporated into the literature distribution system. The “Widgets Price List” contains the current widget prices. These prices may be expected to change over time as Widgets, Inc. adjusts the prices of its products based on supply, demand, and other factors. Thus, the “Widgets Price List” item is assigned an expiration date, namely Jan. 1, 2013 in the illustrative example of FIG. 5. In some embodiments the URL address for this price list item also has an expiration date of Jan. 1, 2013, so that any attempt to download this price list after that date will fail. On the other hand, the “Entire Widgets Product Line” item is indicated as “continually updated”. The product line is likely to change over time as products are added or removed, and so selection of this hyperlink is set to always download the most recent revision of the “Entire Widgets Product Line” item. (This approach could also be used for the price list so that the customer always receives the most current price list. However, if the prices increase after talking with the sales staff at the trade show, the potential customer may be offended to find that the price indicated in the downloaded price list is higher than that quoted by the booth staff—accordingly, it may be better to have a static price list that expires on a specified date, especially if the price list is treated as a binding quote). As seen in FIG. 5, the form text (regular font) of the email explains the various types of links, and also provides a suitably friendly and encouraging dialog prior to listing the hyperlinks.

With reference to FIG. 6, the operations performed by the recipient (John Smith, in the illustrative case) are shown. In an operation S10 the recipient receives and opens the email. This may be done at any time after the email is sent and arrives at the recipient's in-box. In some cases, such as when the recipient is carrying an email-capable mobile device, the recipient may open the email almost in real-time, e.g. while still talking with the sales staff at the vendor's booth. Alternatively, the recipient may not open the email until hours, days, or even weeks later, and may do so either at the trade show physical location 10 or later, e.g. at home or in the office. In an operation S11 the recipient selects an item link, that is, the hyperlink to the LOD item. This creates an HTTP connection between the recipient's device 26, 28, 30 and the secure server 40 and causes the selected item to be downloaded (or streamed) to the recipient's device 26, 28, 30. In an operation S12, the recipient views the downloaded (or streamed) item using an available application (e.g., an application program if viewing on a computer, or an “app” if viewing on a smart phone, tablet computer, or other mobile device). The operation S12 is premised on the assumption that the LOD item is in a “standard” format that is readily viewed on most available devices. For example, if the LOD item is a PDF file, then any PDF viewer application can be used. If the LOD item is audio or video content, then a media viewer app or application program may be used, and so forth. Most mobile devices and personal computers are configured to automatically initiate a download responsive to selecting the hyperlink, detect the type of file being downloaded, and upon completion of the download are further configured to automatically open the appropriate viewing application. The situation for streamed content is similar: most mobile devices and personal computers are configured to automatically initiate streaming responsive to selecting the hyperlink including detecting the stream type, automatically opening the appropriate stream viewing application, and feeding the streamed content to the stream viewing application. Thus, it will be appreciated that most existing general-purpose computers and mobile devices include the requisite email and viewing applications to perform the operations S10, S11, S12. This is advantageous because it means that deployment of the LOD distribution system of FIG. 1 does not entail any modification of the visitor's devices 26, 28, 30. In particular, the LOD app 20 does not need to be loaded onto the visitor's devices 26, 28, 30 (and, indeed, for security purposes it is typically preferred that the distribution of the LOD app 20 be limited to only the sales staff of the vendor).

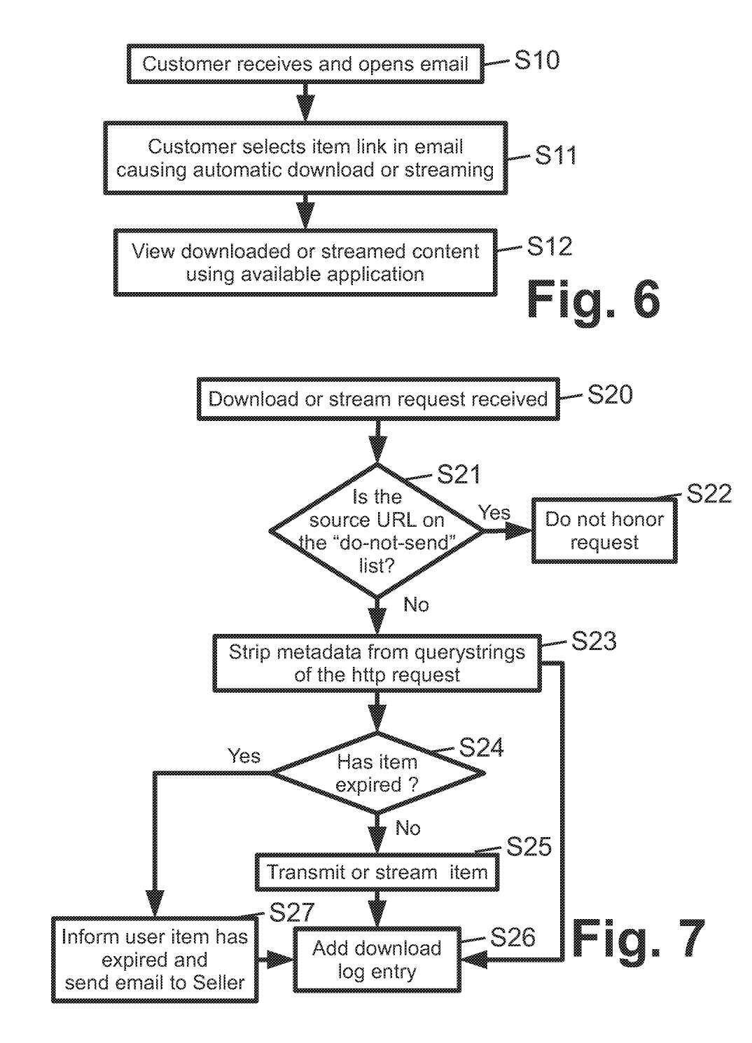

With reference to FIG. 7, operations performed by the secure server 40 responsive to the operation S11 of FIG. 6 (i.e., selecting a hyperlink pointing to a LOD item) are described. In an operation S20, the download (or stream) request is received. In an optional security operation S21, the source URL address from which the request is received is checked against a “do-not-send” list, which typically includes URL addresses of commercial competitors or other entities to which the vendor does not want to distribute literature. The optional operation S21 provides some deterrence against information theft. Some scenarios in which a competitor might obtain an email including a hyperlink to a LOD item in the database 42 of the secure server 40 include: (1) an agent of the competitor operates “undercover” at the trade show and poses as a potential customer in order to lure the sales staff into distributing literature to the agent; or (2) a bona fide potential customer forwards a LOD distribution email to a competitor (for example, in an effort to “negotiate” a better deal from the competitor). Instead of a “do-not-send” list, an alternative is to have a “permitted URL” list that includes only URL addresses to which the system is authorized to send literature. This might be appropriate if, for example, the market for the vendor's products is so small that it is possible to exhaustively identify all possible legitimate customers. The operation S21 can employ other security measures, such as limiting the total number of downloads to a particular URL address over a certain time period (e.g., no more than five items per day). If the security check S21 detects a problem, then process flows to operation S22 which does not honor the download (or stream) request. The operation S22 may optionally take additional action, such as forwarding information about the suspect request to the corporate security and/or legal department(s) for further investigation. The operation S22 may optionally send a reply to the requestor indicating that the request is denied (or other language providing some explanation of why the requested item is not downloaded or streamed). On the other hand, if the security check S21 is passed, then process flows to an operation S23.

In the operation S23, the HTTP request is analyzed to determine the requested download. In one approach, the URL address of each item is of the form:
http://www.widgetscorp.com/download?item=<I>&seller=<S>
   where “<I>” denotes a textual item identifier and “<S>” denotes a textual identifier of the salesperson. The text following the “?” delimiter comprise one or more query strings providing various informational items. In this illustrative example, there are two query strings: one identifying the item, and the other identifying the salesperson (i.e., “seller”). The delimiter “&” separates these two query strings. For the illustrative example in which the salesperson is Ted Smith and for the “Widget.1” brochure item, the URL address is suitably:
http://www.widgetscorp.com/download?item=Widget.1.pdf&seller=Smith.Theodore
   Additional or other query strings may be included to provide other information, such as the recipient's name, recipient's corporate affiliation, and so forth. Moreover, while the fields of the query strings are shown in this example in plain text, in some embodiments the fields may be hashed to form hash codes or otherwise encrypted or obscured, or random number identifiers may be used in place of the file name (such hashing, random number substitution, or so forth being suitably performed at the secure server 40) to enhance security. Still further, other approaches for constructing the URL addresses besides the use of query strings are also contemplated.

In an operation S24, a check is made as to whether the requested item has expired. This pertains to the illustrative example of the price list which has an expiration date of Jan. 1, 2013. If the item has not expired then the requested item is transmitted or streamed in an operation S25, and a corresponding entry is added to the log 48 in an operation S26. On the other hand, if the item has expired then process flows to operation S27 where the user is informed that the item has expired and is no longer available for download. Optionally, the operation S27 may inform the initiating salesperson (identified in the “Seller” query string of the URL address, in the illustrative example) of the failed request so that the salesperson can follow up (e.g., by sending an updated link). Even though the download (or stream) request failed due to expiration of the item, it is generally advantageous to log the request in the log 48 as per operation S26, since the request (even though it failed) indicates affirmative interest in the product or service.

The process of FIG. 7 does not explicitly address the case of a continuously updated item (e.g., the “Entire Widgets Product Line” item of FIG. 5). This is because continuous updating can be automatically provided by updating the item in the LOD database 42 while keeping the URL address unchanged.

With returning reference to FIG. 1, the disclosed literature on-demand (LOD) distribution system can be implemented in various ways. In one approach, the vendor maintains the secure server 40 and provides the LOD app 20 in-house.

In another approach, a service provider other than the vendor maintains the secure server 40 and sells server space and the LOD app 20. In this approach, the secure server 40 typically hosts LOD databases for numerous different vendors, and each LOD app 20 is keyed to a particular LOD database through the use of suitable security measures such as passwords or so forth. For example, the LOD app 20 of a particular vendor may log onto the secure server 40 using a username and password for that vendor.

Although described in the context of a trade show, it will be appreciated that the disclosed LOD distribution system is readily employed more generally in any sales activity. For example, a traveling sales person may be issued the tablet computer 12 with the loaded LOD app 20. The salesperson would then invoke the local LOD database update module 52 prior to leaving on a sales trip, and would carry the tablet computer 12 along on the trip. When the salesperson visits a customer the salesperson uses the viewer module 54 to show various literature items to the customer, and invokes the emailer module 56 to send requested literature items to the customer. The process is as already described with illustrative reference to FIGS. 3-7. Another contemplated variant is a “kiosk” version in which the tablet computer 12 presents categories of literature. The kiosk version can be used by a sales person in which case the categories interface facilitates locating literature of interest. Alternatively, the kiosk version can be employed as a “self-serve” device, for example available for use directly by visitors to the trade show booth. In such embodiments, the visitor can directly fill in the literature delivery form (e.g. FIG. 4, optionally modified to eliminate extraneous fields such as the “Private notes” field) to send literature to the visitor's own email address. In such a self-serve mode, the tablet computer 12 is preferably physically secured to the trade show booth by a security cable or the like.

The inventors have constructed or directed construction of on-demand marketing literature distribution systems substantially in accord with those disclosed herein, with as many as 100 or more electronic data processing devices 12 (typically tablet computers) accessing a common LOD database 42. These LOD distribution systems have been used both in trade show and traveling sales contexts, and for the marketing of both goods and services. In the actually constructed systems, the inventors have constructed or directed construction of the LOD distribution system, while third party clients (and/or their employees and/or agents) select and control the uploading and downloading of literature populating the LOD database 42 of those systems and the linked devices 12 and other operational use of the systems.

The preferred embodiments have been illustrated and described. Obviously, modifications and alterations will occur to others upon reading and understanding the preceding detailed description. It is intended that the invention be construed as including all such modifications and alterations insofar as they come within the scope of the appended claims or the equivalents thereof.

1. A literature on-demand (LOD) distribution system comprising:
a vendor's electronic data processing device on which a LOD application is loaded, the vendor's electronic data processing device being configured to execute the LOD application to perform operations including:
storing a local LOD database containing a portion or all of the LOD items stored in a LOD database hosted at a secure server,
selecting an LOD item stored in the local LOD database,
displaying the selected LOD item or causing the selected LOD item to be displayed by a viewer application executing on the vendor's electronic data processing device,
constructing an email including a hyperlink for downloading or streaming the selected LOD item from the LOD database of the secure server, and
sending the constructed email to a recipient or causing the constructed email to be sent to the recipient by an email application executing on the vendor's electronic data processing device.

2. The LOD distribution system of claim 1 wherein the vendor's electronic data processing device is a mobile device or a notebook or desktop computer.

3. The LOD distribution system of claim 2 wherein the vendor's electronic data processing device is a tablet computer.

4. The LOD distribution system of claim 1 further comprising:
said secure server hosting said LOD database;
wherein the secure server is configured to transmit or stream the selected LOD item to a recipient's electronic data processing device responsive to selection of the hyperlink at the recipient's electronic data processing device.

5. The LOD distribution system of claim 4 wherein the LOD application is not loaded onto the recipient's electronic data processing device.

6. The LOD distribution system of claim 4 wherein the secure server is further configured to keep a log of downloads or streams of LOD items.

7. The LOD distribution system of claim 6 wherein the secure server is further configured to present a visual representation of statistics of the logged downloads or streams of LOD items.

8. The LOD distribution system of claim 4 wherein the secure server is further configured to perform a security check on a URL address associated with the recipient's electronic data processing device and to transmit or stream the selected LOD item only if the URL address passes the security check.

9. The LOD distribution system of claim 8 wherein the security check including one or more of (1) comparing the URL address with a do-not-send list, (2) comparing the URL address with a permitted URL list, and (3) limiting the number of transmit or stream events to the URL address in a predetermined time interval.

10. The LOD distribution system of claim 4 wherein the storing comprises downloading the portion or all of the LOD items stored in the LOD database from the secure server to the vendor's electronic data processing device via the Internet.

11. The LOD distribution system of claim 1 wherein:
the vendor's electronic data processing device is configured to connect with the Internet and the sending operation is performed via the Internet, and
the vendor's electronic data processing device is configured to perform the selecting, displaying, and constructing operations without an Internet connection and to delay the sending operation until the vendor's electronic data processing device is connected with the Internet.

12. The LOD distribution system of claim 1 wherein:
the vendor's electronic data processing device is configured to connect with the Internet and the sending operation is performed via the Internet, and
the vendor's electronic data processing device is configured to perform the selecting, displaying, and constructing operations using the local LOD database without an Internet connection.

13. A non-transitory storage medium storing instructions executable by an electronic data processing device to perform a method including: selecting a literature on-demand (LOD) item stored in a local LOD database containing content downloaded from an LOD database hosted at a secure server; displaying the selected LOD item or causing the selected LOD item to be displayed by a viewer application executing on the electronic data processing device; constructing an email including a hyperlink for downloading or streaming the selected LOD item from the LOD database of the secure server; and sending the constructed email to a recipient or causing the constructed email to be sent to the recipient by an email application executing on the electronic data processing device.

14. The non-transitory storage medium of claim 13 wherein:
the sending operation utilizes the Internet, and
the selecting, displaying, and constructing operations are performed using the local LOD database and do not utilize the Internet.

15. The non-transitory storage medium of claim 14 wherein the method further comprises delaying the sending until an Internet connection is available.

16. The non-transitory storage medium of claim 14 wherein the method further comprises downloading the local LOD database from a remote server to the electronic data processing device via the Internet.

17. A literature on-demand (LOD) distribution system comprising:
a server connected with the Internet and hosting a LOD database storing LOD items, the server configured to:
connect with authenticated mobile electronic data processing devices via the Internet and download portions or all of the LOD items stored in the LOD database to the authenticated mobile electronic data processing devices via the Internet connection; and
transmit or stream a LOD item to a recipient electronic data processing device via the Internet responsive to receipt of a request for the LOD item by selection of a hyperlink at the recipient's electronic data processing device identifying the LOD item.

18. The LOD distribution system of claim 17 wherein the transmit or stream operation includes logging the transmit or stream event including an identification of the recipient at the server.

19. The LOD distribution system of claim 17 wherein the transmit or stream operation includes performing a security check on a URL address associated with the hyperlink and transmitting or streaming the selected LOD item only if the URL address passes the security check.
